(19) United States
(12) Patent Application Publication
(10) Pub. No.: US 2005/0017969 A1
(43) Pub. Date: Jan. 27, 2005

(54) Computer graphics rendering using boundary information

(76) Inventors: Pradeep Sen, Palo Alto, CA (US); Michael Cammarano, Bradenton, FL (US); Patrick M. Hanrahan, Portola Valley, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/857,163

(22) Filed: May 27, 2004

Related U.S. Application Data
(60) Provisional application No. 60/473,850, filed on May 27, 2003.

(51) Int. Cl. G06T 15/00

(52) U.S. Cl. 345/419

(57) ABSTRACT

A method for computer graphics rendering system uses a silhouette map containing boundary position information that is used to reconstruct precise boundaries in the rendered image, even under high magnification. In one embodiment the silhouette map is used together with a depth map to precisely render the edges of shadows. In another embodiment, the silhouette map is used together with a bitmap texture to precisely render the borders between differently colored regions of the bitmap. The technique may be implemented in software, on programmable graphics hardware in real-time, or with custom hardware.

### CROSS-REFERENCE TO RELATED APPLICATIONS

This application claims priority from U.S. provisional patent application No. 60/473,850 filed May 27, 2003, which is incorporated herein by reference.

### STATEMENT OF GOVERNMENT SPONSORED SUPPORT

This invention was supported by contract number F29601-01-2-0085 from DARPA. The US Government has certain rights in the invention.

### FIELD OF THE INVENTION

The present invention relates to computer graphics rendering techniques. More specifically, it relates to improved methods for faithfully rendering boundaries such as shadow silhouette boundaries and texture boundaries.

### BACKGROUND OF THE INVENTION

In the field of computer graphics, considerable research has focused on rendering, i.e., the process of generating a two-dimensional image from a higher-dimensional representation, such as a description of a three-dimensional scene. For example, given a description of a three-dimensional object, a rendering method might generate a two-dimensional image for display on a computer screen. A desirable rendering method generates a two-dimensional image that is a faithful and realistic rendering of the higher-dimensional scene. For example, a desirable rendering should be a correct perspective view of the scene from a particular viewpoint, it should appropriately hide portions of objects that are behind other objects in the scene, it should include accurate shading to show shadows, and it should have distinct boundaries at edges of objects, edges of shadows, and at edges of differently colored regions on the surfaces of objects. These and other desirable properties of rendering, however, can introduce substantial computational complexity which introduces problems due to practical limitations in computational resources. For example, a rendering technique suitable for real-time applications should be fast and should not require excessive memory. Therefore, it is a significant challenge in the art of computer graphics to discover rendering techniques that are both practical to implement and provide realistic results.

Texture mapping is a known technique used in computer rendering to add visual realism to a rendered scene without introducing large computational complexity. A texture is a data structure that contains an array of texture element (texel) values associated with a two-dimensional grid of cells. For example, a bitmap image of the surface of an object is an example of a texture where each texel is a pixel of the bitmap image. During the rendering process, the texture is sampled and mapped to the rendered image pixels. This mapping process, however, can result in undesirable artifacts in the rendered image, especially when the texture's grid does not correspond well with the grid of pixels in the rendered image. This mismatch can be especially pronounced when the object is magnified or minified (i.e., viewed up close or very far away). Known techniques such as the use of mipmaps are known to effectively render minified textures without artifacts. A mipmap is a pyramidal data structure that stores filtered versions of a texture at various lower resolutions. During rendering, the appropriate lower-resolution version of the texture (or a linear interpolation between two versions) can be used to generate a minified texture. Rendering magnified textures without artifacts, however, remains a problem. Because textures are discrete data structures, highly magnifying a texture results in noticeable pixelation artifacts in the rendered image, i.e., the appearance of jagged color discontinuities in the image where there should not be any. The technique of bilinear interpolation can be used to alleviate pixelation when rendering highly magnified textures. Interpolation, however, results in a blurry rendered image lacking definition. The brute-force approach of simply storing higher resolution textures increases memory requirements and can also increase computational complexity if compressed textures are used.

Similar problems exist when rendering shadows. A common shadow generation method, called shadow mapping, uses a particular type of texture called a depth map, or shadow map. Each texel of a depth map stores a depth value representing a distance along the ray going through that texel from a light source to the nearest point in the scene. This depth map texture is then used when rendering the scene to determine shadowing on the surface of objects. These depth map textures, however, have the same rendering problems as the previously discussed textures. Specifically, when the grid of the depth map texture does not correspond well with the grid of pixels in the rendered image rendering artifacts appear. In particular, under high magnification the shadow boundaries in the rendered image will be jagged or, if a filtering technique is used, the shadow boundaries will be very blurry.

In view of the above, it would be an advance in the art of computer graphics to overcome these problems associated with conventional rendering techniques. It would also be an advance in the art to overcome these problems with a technique that does not require large amounts of memory, is not computationally complex, and can be implemented in current graphics hardware for use in real-time applications.

### SUMMARY OF THE INVENTION

In one aspect, the present invention provides a new graphics rendering technique that renders textures of various types in real time with improved texture rendering at high magnification levels. Specifically, the techniques accurately render shadow boundaries and other boundaries within highly magnified textures without blurring or pixelation artifacts. Moreover, the techniques can be implemented in existing graphics hardware in constant time, have bounded complexity, and do not require large amounts of memory.

According to one aspect, the method uses a novel silhouette map to improve texture mapping. The silhouette map, also called a silmap, embodies boundary position information which enables a texture to be mapped to a rendered image under high magnification without blurring or pixelation of boundaries between distinct regions within the texture. In one embodiment, the texture is a bitmap texture and the silmap contains boundary information about the position of boundaries between differently colored regions in the texture. In another embodiment, the texture is a depth map and the silmap contains boundary information about the position of shadow boundaries. In some embodiments, the silmap and the texture are represented by two arrays of values, corresponding to a pair of two-dimensional grids of cells. In a preferred embodiment, the two grids are offset by one-half of a cell width and the boundary information of each cell in the silmap comprises coordinates of a boundary point in the cell. In another embodiment, the boundary information in the silmap cells comprise grid deformation information for the texture grid. In a preferred embodiment, the representation of the silmap satisfies two main criteria. First, the representation preferably provides information sufficient to reconstruct a continuous boundary. Second, the information preferably is easy to store and sample.

According to another aspect of the invention, methods are provided for generating a silmap suitable for use in rendering techniques of the invention. In one embodiment useful for shadow rendering, a silmap generation technique determines shadow silhouettes in realtime from the scene geometry for each frame and stores precise position information of the silhouette boundary in a silmap. This silmap may then be used together with a conventional depth map to provide precise rendering of shadow edges. In another embodiment useful for texture rendering, a silmap is generated from a bitmap using edge detection algorithms performed prior to rendering. In yet another embodiment, a silmap is generated by a human using graphics editing software. In other embodiments, the above techniques for silmap generation are combined.

According to one implementation of a technique for generating a silmap, a boundary contour representing shadow or region edge information is approximated by a series of connected line segments to produce a piecewise linear contour. This piecewise linear contour is then rasterized to identify cells of the silmap through which the contour passes or nearly passes. Within each of these identified cells, if the contour passes through the cell, a silhouette point on the contour is selected and stored in the texel corresponding to the cell. The silhouette points may be represented as relative (x, y) coordinates within each cell. The silhouette point in a cell thus provides position information for the boundary passing through the cell. During rendering, the original boundary contour is reconstructed from the silmap by fitting a smooth or piecewise linear curve to the silhouette points stored in the silmap.

According to another aspect of the invention, a method is provided for rendering shadows using a shadow silmap and a depth map. For a given pixel in the rendered image, its corresponding point in the scene is projected onto the depth map grid in light space to obtain a projected point, and the four closest depth map values in the depth map grid are compared to the depth of the point in the scene. If all four values indicate that the point is lit or that the point is shadowed, then the pixel in the rendered image is shaded accordingly. If any one of the four depth comparisons disagrees with another, however, a shadow boundary must pass near the point. In this case, the silmap points are used to determine a precise shadow edge position relative to the projected point and to shade the pixel in the rendered image appropriately.

In another aspect, an improved method is provided for rendering bitmap textures using a silmap that embodies position information about boundaries between differently colored regions of the bitmap texture. For a given pixel in the rendered image, its corresponding point in the scene is projected onto the texture grid to obtain a projected point. The silmap points in proximity to the projected point are used to determine a precise boundary position relative to the projected point to determine a set of nearby bitmap texture color values that are located in the same region of the projected point. The set of nearby color values are then filtered to determine the color of the rendered pixel. Preferably, a color for the pixel in the rendered image is determined through filtering the set of nearby bitmap texture color values in the same region of the projected point.

### BRIEF DESCRIPTION OF THE DRAWINGS

FIGS. 1A and 1B contrast the results of the standard shadow map technique of the prior art with the results of the silhouette map technique of an embodiment of the present invention.

FIG. 2A is a flow chart of the main steps according to a shadow rendering embodiment of the present invention.

FIG. 2B is a flow chart illustrating details of a shadow rendering embodiment of the present invention.

FIG. 2C is a flow chart illustrating details of a bitmap texture rendering embodiment of the present invention.

FIGS. 3A, 3B, and 3C illustrate the steps of generating a shadow silhouette map according to one embodiment of the invention.

FIGS. 4A-4D illustrate a technique for selecting silhouette map points by intersecting a silhouette line segment with a texel according to an embodiment of the invention.

FIGS. 5A-F show six possible combinations of depth test results and shadowing configurations for a single texel according to an embodiment of the invention.

FIGS. 6A-C illustrate how a point of the scene is shaded in a texel by determining in which region of the texel it lies.

FIGS. 7A-B show how the silhouette map technique of the present invention may be represented in terms of a discontinuity meshing of a finite element grid.

FIG. 8 is a graphical representation of a silmap showing its grid of cells, its silmap points, and a reconstructed boundary separating differently colored regions.

FIGS. 9A-C illustrates how silmap boundary connectivity information can be used to select one of multiple possible reconstructed boundaries that are consistent with the same set of silmap points.

FIGS. 10A-D show four cases for how a projected point may be related to a reconstructed boundary passing through a cell.

FIGS. 11A-B illustrate a technique for determining corners associated with a projected point in a silmap cell according to one embodiment of the invention.

### DETAILED DESCRIPTION

The techniques of the present invention, like other graphical rendering techniques, may be implemented in a variety of ways, as is well known in the art. For example, they may be implemented in hardware, firmware, software, or any combination of the three. To give just one concrete example, the technique may be implemented on the ATI Radeon 9700. Pro using ARB_vertex_program and ARB_fragment_program shaders. It is an advantage of the present invention that the rendering techniques may be efficiently implemented in current graphics hardware. In addition, they have constant time and bounded complexity.

Those skilled in the art of computer graphics will appreciate from the present description that the techniques of the present invention have many possible implementations and embodiments. Several specific embodiments will now be described in detail to illustrate the principles of the invention. First, we will describe embodiments related to shadow rendering, followed by embodiments related to rendering bitmap textures. The detailed description will conclude with a discussion of other possible embodiments.

Shadow Rendering Embodiments

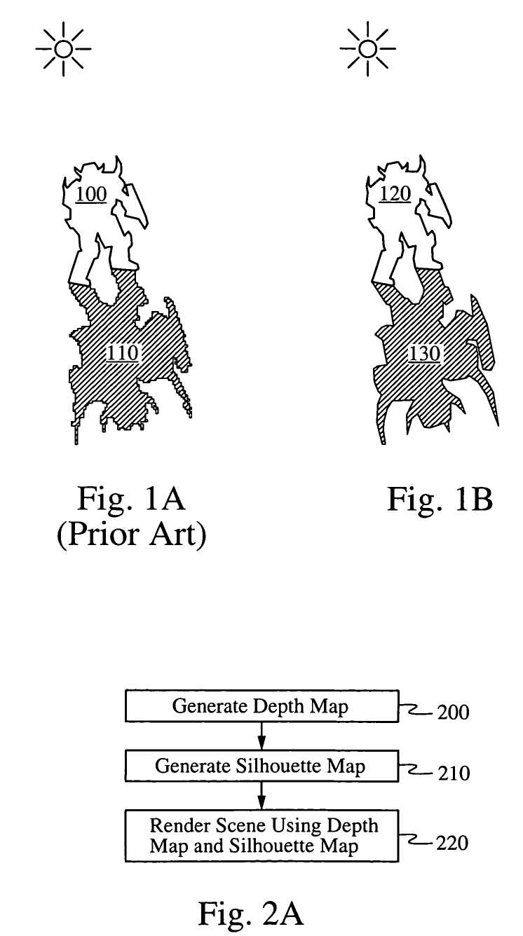

FIGS. 1A and 1B illustrate the improvement provided by the techniques of an embodiment of the invention applied to rendering shadows. FIG. 1A shows a scene rendered using standard shadow map techniques, while FIG. 1B shows the same scene rendered using a shadow silmap, according to one embodiment of the present invention. The primary difference between the two images is the precision of the shadow silhouettes, i.e., the boundary between shadow and light. In FIG. 1A the FIG. 100 casts a shadow 110 whose edges are jagged and imprecise, while in FIG. 1B the FIG. 120 casts a shadow 130 whose edges are comparatively smooth and precise.

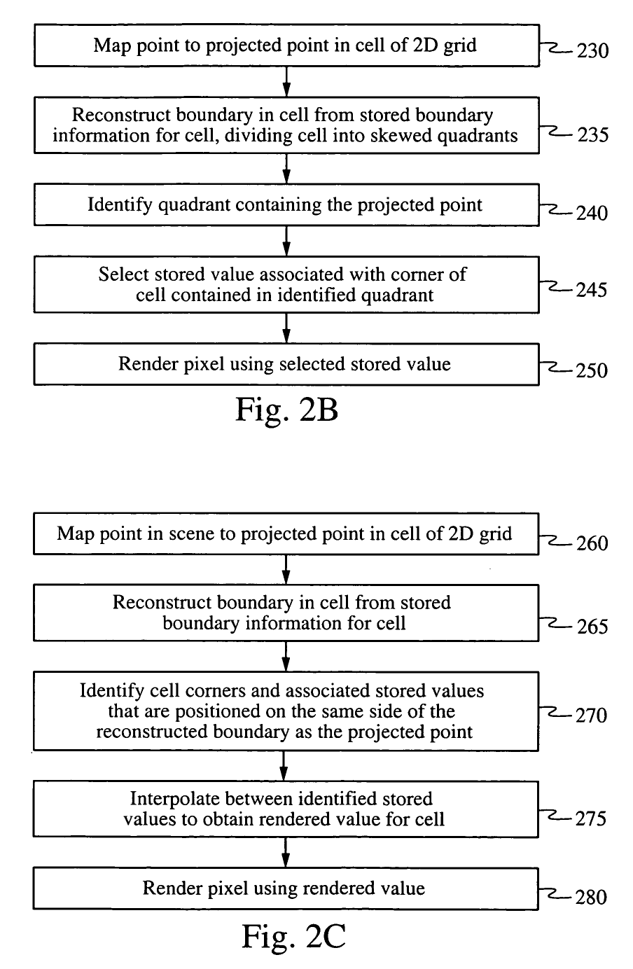

In one embodiment of the invention, the technique involves three rendering passes, as shown in FIG. 2. A first pass 200 creates a conventional shadow depth map, a second pass 210 creates a shadow silmap, and a third pass 220 renders the scene and evaluates shadowing for each pixel in the rendered scene. The first pass 200 renders a depth map of the scene from the point of view of the light, and may use any of the conventional shadow map techniques known in the art. Because this pass is otherwise identical to existing implementations of depth map generation, the following discussion will focus primarily on the second pass 210 and the third pass 220, which involve the shadow silmap generation and its use in rendering the scene. Although the first and second passes, 200 and 210, are separately described here, they can be implemented either as a single pass (preferably with hardware support) or as two separate passes.

Generating the Shadow Silhouette Map

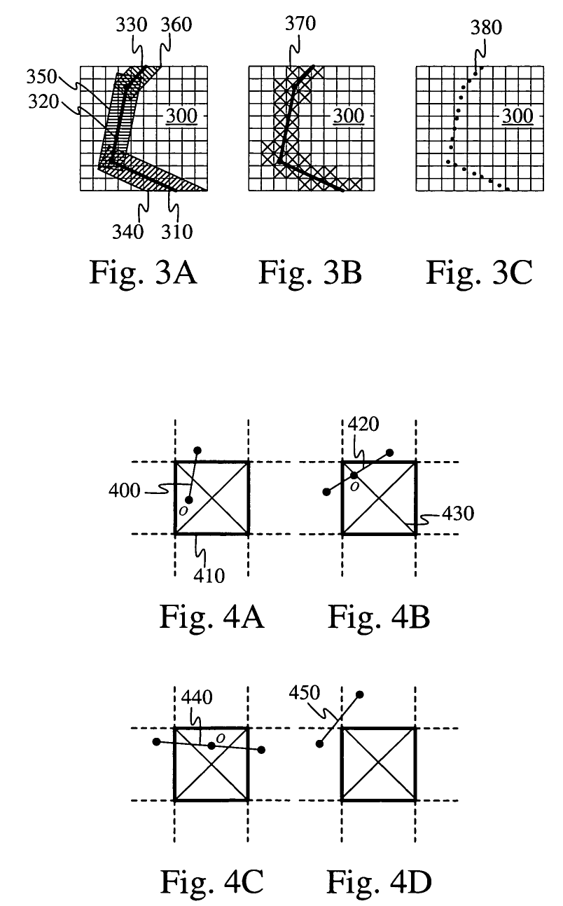

According to one embodiment of the invention, a shadow silmap may be generated from a scene by the following steps. From a three-dimensional representation of a scene and a light direction or light source viewpoint a shadow boundary contour is generated in the plane of a silmap grid. Preferably, the silmap grid and the depth map grids are in the same plane and are offset from each other by half a cell. The shadow boundary contour is then approximated by a series of line segments to produce a piecewise linear contour composed of connected silhouette edge line segments. FIGS. 3A, 3B, and 3C illustrate steps of generating a shadow silmap points from these line segments. This process includes rasterizing the silhouette edge line segments into the shadow silmap cells using rectangles, as illustrated in FIG. 3A. The figure shows a portion of a silmap grid 300 including three shadow contour line segments 310, 320, 330 with corresponding rectangles 340, 350, 360 surrounding them. The rectangle region is drawn around each of the line segments to ensure that every cell intersected by a line segment will be rasterized (i.e., fragments or pixel objects are generated for every cell intersected by the line segment). The width of each rectangle is chosen to be just large enough to guarantee that a fragment is generated for every cell intersected by the line segment. In other words, the cells cover the piecewise linear contour. To draw the rectangle, the vertices on either side of the line segment are simply offset by a small distance in a direction perpendicular to the line segment. In addition, the rectangles are made slightly longer than the line segments to guarantee that the end points of the line segments are rasterized as well. FIG. 3B shows the rasterized fragments (shown as cells 370 with an “X” in them) that intersect the rectangles. Since the rectangle sizes are chosen conservatively, a few fragments that do not overlap the line segment may also be generated. Finally, as illustrated in FIG. 3C, a set of points of the silhouette map are generated by selecting, for each of the rasterized cells, a point in the cell on the line segment passing through the cell. If a line segment does not pass through the cell, no point is selected.

FIGS. 4A-4D illustrate in more detail one of the many possible techniques for selecting the silmap points by intersecting a silhouette line segment with a silmap cell. The point that will be selected for storage in the silmap is labeled in each figure with an “O.” The fragment program that selects the point on the line segment ensures that the point is actually inside the cell. To perform this test, the two endpoints of the line segment are passed as vertex parameters to the fragment program. If one of the vertices is inside the cell, we know trivially that the line segment intersects the cell and the vertex is selected as the point to be stored in the silmap for that cell. FIG. 4A shows this case where a vertex of a line segment 400 is inside the cell 410. In this case, that vertex is selected. (If both vertices are inside the cell, either one of the two may be selected.) If neither vertex is in the cell, then the line segment is tested to see whether it intersects the two diagonals of the cell once, twice, or not at all. FIG. 4B shows the case where the line segment 420 intersects just one diagonal 430 of the cell. In this case, the point of intersection is selected. FIG. 4C shows the case where the line segment 440 intersects two diagonals in two places. In this case, the selected point is the midpoint between the two intersections. Finally, FIG. 4D shows the case where the line segment 450 does not intersect either diagonal. In this case, the line does not intersect the cell and no point is selected for that cell. This technique can be implemented in an ARB fragment program. This is one of several techniques that can be used to select points that lie on the silhouette edge to store in the silmap. In other embodiments of the invention, alternative techniques may be employed to represent boundary information in the silmap. For example, rather than using silhouette points that intersect diagonals in the interior of the cells, an alternate implementation might use points where the silhouette crosses the edges of the cells.

To provide high precision, the coordinates of the silhouette points are preferably represented in the local coordinate frame of each cell. In one embodiment, the origin may be defined to be located at the bottom-left corner of each cell. In the fragment program, the vertices of the line are preferably translated into this reference frame before performing the intersection calculations. In addition, it is also preferable to ensure that only visible silhouettes edges are rasterized into the silmap. To do this properly, the depth of the fragment is compared to that of the four corner samples. If the fragment is farther from the light than all four corner samples, the fragment is killed, preventing it from writing into the silmap.

An implementation of shadow silhouette map generation preferably also handles the case where the silhouette line passes through the corner of a cell. In these situations, to avoid artifacts and ensure the 4-connectedness of the silhouette map representation, it is preferable to consider lines that pass near cell corners (within limits of precision) as passing through all four neighboring cells. To do this, the clipping cell is enlarged slightly to allow intersections to be valid just outside the square region. When the final point is computed, the fragment program clamps it to the cell to ensure that all the points stored in a texel are always inside the cell for the texel.

Shadow Rendering

According to another embodiment of the invention, a method is provided for rendering shadows using a shadow silmap together with the depth map, as shown in FIG. 2B. To determine if a pixel in the rendered image should be shaded, its corresponding point in the scene is projected into the plane of the silmap map grid to obtain a projected point (step 230). For example, FIG. 6A shows a silmap cell containing a projected point, indicated by a solid dot labeled “O”. The silmap cell also contains a silmap point, indicated by a hollow dot. Silmap points in adjacent cells are also shown. The silmap grid preferably is in the same plane as the depth map grid, but offset by half a cell so that each cell corner in the silmap corresponds to a unique depth map cell.

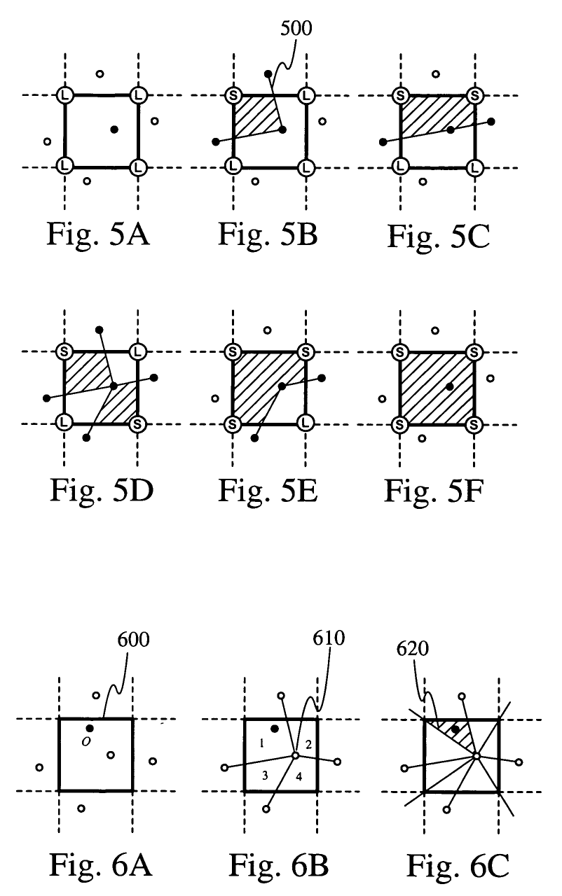

The shading of the projected point (and hence the corresponding pixel in the rendered image) may be determined by performing various tests and deciding appropriate shading based on the results of the tests. The first test involves only the conventional depth map. The depth value of the point in the silmap cell is compared with the depth values of the four shadow depth map values that correspond to the four corners of the silmap cell. If they all indicate that the silmap cell is lit or they all indicate that it is shadowed, then this cell does not have a silhouette boundary going through it and the pixel in the rendered image is shaded accordingly. For example, FIG. 5A illustrates the case where all four corners are lit (labeled “L”) and FIG. 5F illustrates the case where all four corners are shaded (labeled “S”).

If any one of the corners has a different test result from the others, a shadow boundary must pass through the cell. These cases are illustrated in FIGS. 5B-5E. As shown in steps 235 and 240 of FIG. 2B, in these intermediate cases, the boundary information stored in the silmap is used to reconstruct a shadow boundary within the cell (e.g., by connecting the dots to form a piecewise linear contour) and determine whether the projected point is positioned on a shaded or unshaded side of the boundary. FIGS. 5A-F show six possible combinations of depth test results and shadowing configurations for a single cell of the silmap. The depth test value at each corner of the depth map is denoted by an “L” or an “S” indicating lit and shadowed, respectively, and the reconstructed boundary 500 separates shaded and unshaded regions of the cell. Smaller solid dots indicate silhouette points. FIG. 5A shows the case where all the corners are lit, FIG. 5B shows one corner shadowed, FIGS. 5C and 5D show two corners shadowed, FIG. 5E shows three corners shadowed, and FIG. 5F shows the case where all the corners are shadowed. As illustrated by the figures, the silmap point positions within the cells and the depth map values at the corners of the cells determine shaded and unshaded regions within each cell, where the regions are separated by the reconstructed shadow boundary.

FIG. 6A shows a projected sample point “O” (solid dot) inside a cell 600 of the silmap. As shown in FIG. 6B, line segments connecting the cell's silmap point 610 to the four silmap points in adjacent cells divide the cell into four skewed cell quadrants. The appropriate shading of the projected point “O” (and hence the corresponding pixel in the rendered image) may be found by determining the cell quadrant in which the point is positioned and the shading of that quadrant. Because each quadrant is shaded in the same manner as its corner point, the pixel in the rendered image is shaded appropriately based on the result of the depth test for that quadrant's corner (steps 245 and 250 of FIG. 2B). In the example shown in FIG. 6B, the point is in quadrant 1, so it is shaded based on the depth sample at the top-left corner of the cell. In general, the result of the appropriate corner depth test determines how to shade points on that corner's side of the silhouette boundary. To determine in which of these four quadrants the projected sample point lies, simple line tests may be used. One implementation performs the line tests as follows. First, a cross product between the silhouette point in the current cell (considered as a vector) and each of the four neighbors is performed to yield four line equations. A dot product between the sample point (considered as a vector) and these four lines can be used to determine in which of the four quadrants the sample is located. This is straightforward because the dot product will have different signs (positive or negative) depending which side of the line the sample point is on. Thus, the quadrant can be identified by ensuring that each of the two dot products have the appropriate sign (the signs may have to be different, depending on the quadrant). An accelerated implementation needs only to test against three quadrants and will assume that the sample point is in the fourth quadrant if the point is not in any of the first three.

Floating point precision limitations might cause unsightly cracks to appear in the above implementation. Thus, for hardware with lower floating point precision, one implementation adds lines to the corners of the cell. This creates eight pie-shaped wedges 620, two for each skewed quadrant, as shown in FIG. 6C. The projected sample point can then be tested against each of these wedges just as it was tested against the quadrant. This implementation requires more computation but is more tolerant of precision limitations in the hardware.

The present technique may reconstruct the silhouette boundary curve from the silhouette points by connecting the points with line segments to form a piecewise linear curve, or by fitting a higher order curve to the points (e.g., a spline). Regardless of the reconstruction technique used, the boundary curve passes through the cell with sub-cell resolution limited only by the numerical precision used for representing the silhouette point within each cell. As a result, the silmap can be highly magnified and still provide a smooth, high-resolution silhouette boundary in the rendered image. This important advantage is provided with minimal increase in computational complexity.

Since the depth is sampled at discrete spatial intervals and with finite precision, it is preferable to place a default silhouette point in the center of every silmap cell, or to assume that such a default point is present if a cell has no point stored in it. In other words, if a silmap cell has no silhouette point, the algorithm assumes the point is in the center of the cell. The default point makes the technique more robust.

Shadow silhouette maps may be used in combination with various known techniques such as Stamminger's perspective shadow maps techniques. While Stamminger's technique optimizes the distribution of shadow samples to better match the sampling of the final image, the silmap technique increases the amount of useful information provided by each sample. The two techniques could be advantageously combined to yield the benefits of both.

There are three parts of the technique that are preferably implemented in hardware: the determination of silhouette edges while generating the silhouette map, the rasterization steps (which may involve constructing rectangles depending on the hardware used) and selecting silhouette points in the later stages of generating the silhouette map, and conditional execution of arithmetic and texture fetches when rendering shadows. It is preferable to support the entire silhouette map technique as a primitive texture operation in hardware.

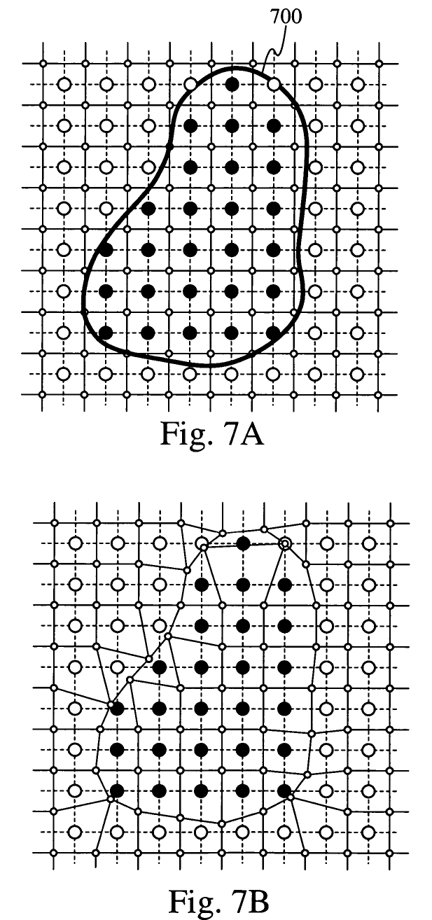

As illustrated in the above description, embodiments of the invention make use of a novel silhouette map which includes a piecewise-linear approximation to the silhouette boundary. This method may also be described as a two-dimensional form of dual contouring. Alternatively, one may think of the silhouette map technique in terms of a discontinuity meshing of a finite element grid. Discontinuity meshing is a meshing in the domain of a function so that edges of the mesh align to discontinuities in the function. A silhouette map is a discontinuity mesh that represents the discontinuities of light: some areas are lit, some are not, and the boundaries of the shadow form the discontinuities. Starting with a regular grid of depth samples, where each grid cell contains a single value, the grid is deformed to follow the shadow silhouette contour. FIG. 7A shows a contour 700 superimposed on such a grid. The large solid dots indicate a shaded region with different depth values than the large hollow dots. The small hollow dots are silmap points within silmap cells of the silmap grid. This grid is then locally warped near the silhouette boundary 700 by moving the silmap points so that the edges of grid cells are aligned with boundaries formed by the shadow edges, as shown in FIG. 7B. The mesh is warped when the silmap points are positioned at locations other than the default position in the center of the cells. Thus, when silhouette map points are at the center of the cells, the regular grid is undeformed.

Those skilled in the art will appreciate from the above description that silhouette maps may use various alternative representations to store the boundary information. Instead of using a single point as the silhouette map representation, other data representations such as edge equations may be to approximate silhouettes. Representing the silhouette edge using points, however, is a preferred representation. It requires the storing of only two parameters (the relative x and y offsets) per silhouette map texel. Nevertheless, many other silhouette representations are possible and may have benefits for specific geometries. In addition, this technique may be extended from hard shadows to include soft shadows as well.

Rendering Bitmap Textures

The present invention may also be applied to rendering bitmap textures. For example, according to another embodiment, a silmap embodies position information about boundaries between differently colored regions of the bitmap texture. This boundary information in the silmap can then be used to render bitmap textures at high resolution without pixelation or blurring artifacts.

Generating Silmaps

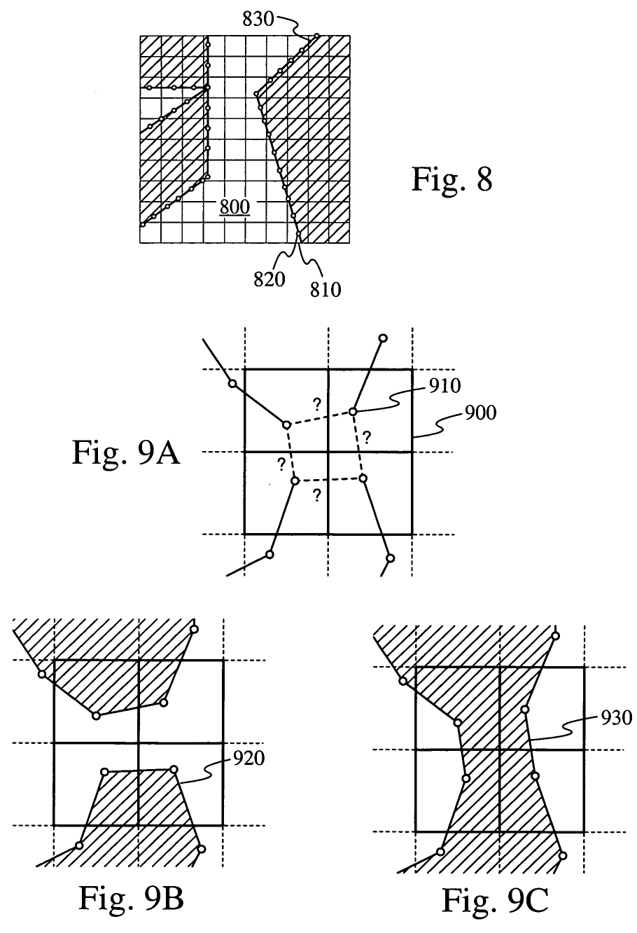

A silmap suitable for rendering bitmap textures according to the present invention may be generated in various ways. For example, a digital image representing the surface of an object may be processed using edge detection techniques to identify boundary contours between differently colored regions in the image. Like shadow contours, these color boundary contours may be processed in the same manner described above in relation to FIGS. 3A-C to obtain silmap points. FIG. 8 illustrates a portion of a silmap 800 generated from an image, showing the silmap cells 810, associated silmap points 820, and corresponding boundary contour 830 separating regions of different colors. In yet another embodiment, a silmap is generated by a human using graphics editing software. For example, a digital image representing the surface of an object is imported into the application program and the user draws first order (i.e., piecewise linear) or higher order curves on top of the image to identify boundary contours between differently colored regions. The boundary contours are then processed as described above to identify the silmap points and store them in the silmap. In other embodiments, the above two techniques for silmap generation are combined. For example, after automatic edge detection, a user may edit, delete, or create boundary contours. Other embodiments may also include steps to automatically or manually identify and correct defects in the silmap so that it does not produce artifacts during real-time rendering.

In some embodiments of the invention, the silmap boundary information contains, in addition to silmap boundary points, silmap boundary connectivity information. For example, the boundary connectivity information may indicate whether the silmap points in two adjacent cells are part of the same locally connected boundary or are part of two locally distinct boundaries. FIG. 9A, for example, shows a group of adjacent silmap cells 900 and associated silmap points 910 contained within them. The silmap points alone are consistent with two distinct boundary reconstructions 920 and 930, as shown in FIGS. 9B and 9C. The boundary connectivity information preferable comprises a bit for each possible edge to indicate whether or not it is valid (thus, two bits are needed per cell, since neighboring cells also have connectivity information). Alternatively, the boundary connectivity information can take the form of region information stored at each cell corner. Boundary connectivity is directly inferred from the region information stored at each cell corner, as is evident by comparing the difference in shading of the central corner in FIGS. 9B and 9C.

Rendering Bitmap Textures Using a Silmap

According to another embodiment of the invention, a method is provided for rendering a bitmap texture using a silmap containing position information for boundaries between differently colored regions of the bitmap. The steps of this method are shown in FIG. 2C. For a given pixel in the rendered image, its corresponding point in the scene is projected onto the silmap grid to obtain a projected point within one of the silmap cells (step 260). The grid of the silmap is contained in a plane that also contains a grid of the bitmap texture. Preferably, the two grids are offset from each other by half of a cell so that the corners of each silmap cell correspond to four neighboring color values in the bitmap texture.

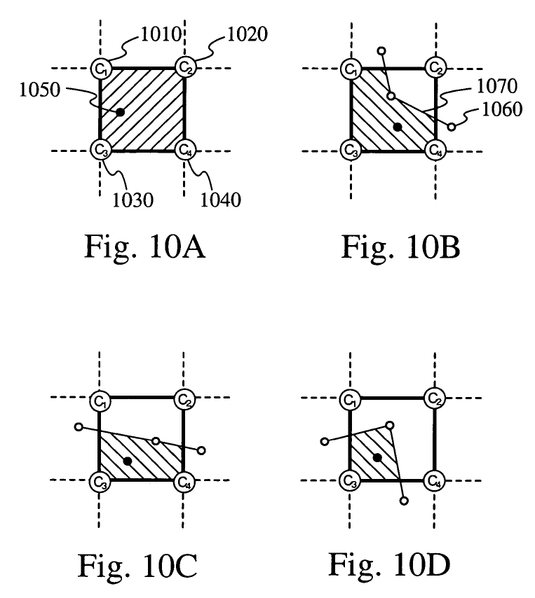

If the projected point is contained in a cell that contains no silmap boundary, then the color of the cell is preferably computed by interpolating between the four colors 1010, 1020, 1030, 1040 of the bitmap at the corners of the cell, as shown in FIG. 10A. For example, the interpolation may use bilinear interpolation that weights the colors 1010 based on the distance from the projected point 1050 to each of the four corners, as illustrated in FIG. 10A. The pixel corresponding to the projected point is then assigned the color resulting from the interpolation. If, as shown in FIG. 10B, the cell contains a silmap boundary, then the silmap points 1060 in adjacent cells are used reconstruct a precise boundary position 1070 within the cell (FIG. 2C, step 265). (In cases where the silmap contains boundary connectivity information, that information may be used to uniquely determine the reconstructed boundary position.) The reconstructed boundary will divide the cell into differently colored regions. FIGS. 10B, 10C, and 10D illustrate three cases: 1) the projected point is located in a region containing three corners, 2) the point is in a region containing two corners, and 3) the point is in a region containing one corner. Using line test techniques analogous to those described above in the shadow rendering embodiment, the position of the projected point relative to the boundary is determined so that the point can be placed in one of the regions (FIG. 2C, step 270). The region of the sample point is then compared to that of the corners to decide if it is in the same region as 1, 2, 3, or all 4 corners.

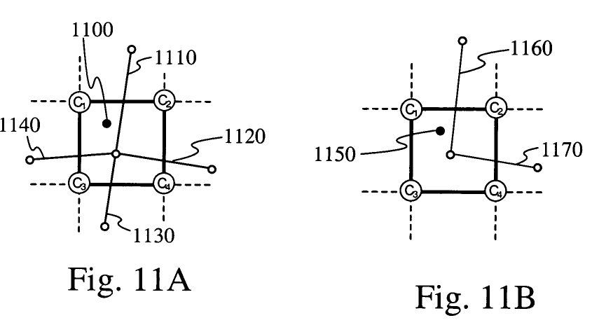

In the embodiment where the boundary information is directly encoded in each cell, we determine which corners are in the same region as the sample point by testing against the boundary edges. As an example, see FIG. 11A. Assume that the sample point 1100 is in the upper-left skewed quadrant and our boundaries are represented by variables line_N (1110), line_S (1130), line_E (1120), line_W (1140). If the line variable is 0, this means that no boundary exists, and if it is 1 then there is a boundary at that location. First of all, the corner value at the same quadrant is automatically included in the region, so in this case C1 would be in our region because the sample is in the same quadrant as C1. C2 will be included in the region only if line_N is 0. Likewise, C3 will be included if line_W is 0. Finally, in order to include C4, we must have an open route from the sample point to that corner. This means that both line_N and line_E should be 0 or line_W and line_S should both be 0. To demonstrate this embodiment for a specific case, see FIG. 11B which shows one possible configuration. In this case, only line_N (1160) and line_E (1170) are set to 1 (because there are lines there) and the others are set to 0. Thus the sample point 1150 will be deemed to be in the same region as C1, C3, and C4. Thus only C1, C3, and C4 will be used in the filtering process. It is straightforward to implement this algorithm to handle all the possible cases and positions of the sample.

The identified region determines a set of nearby bitmap texture color values that are located in the same region of the projected point. In the example of FIG. 10B, there are three bitmap texture color values associated with the three corners in the identified region. In the example of FIG. 10C, there are two color values associated with the two corners in the identified region, and in FIG. 10D there is just one color value associated with the one corner in the identified region. The set color values are then interpolated to determine the color of the rendered pixel (FIG. 2C, steps 275 and 280). In the case shown in FIG. 10C where there are two corners, the two colors associated with the corners are linearly interpolated to obtain the resulting color for the projected point. In the case shown in FIG. 10B interpolation is performed between the color values associated with the three corners. The case of a single corner, shown in FIG. 10D, requires no interpolation. The color computation for these cases can be summarized as follows:

TABLE 1

| Corners in Region | Color of Point (x,y) |
|---|---|
| C₁ | C₁ |
| C₁, C₂ | (1 − x)C₁ + xC₂ |
| C₁, C₃, C₄ | (1 − x − y)C₃ + xC₄ + yC₁ |
| C₁, C₂, C₃, C₄ | (1 − y)[(1 − x)C₁ + xC₂] + y[(1 − x)C₃ + xC₄] |

Analogous formulas may be used for other combinations of corners. It should be noted that the third formula can produce a negative coefficient for C₃ if x+y>1. In this case, it is preferable to perform a per-component clamp, or to scale the vector (x,y) so that x+y=1.

There are other possible formulas to implement the interpolation. In general, the colors associated with corners that are separated from the projected point by the boundary are not included in the interpolation, while the corners that are on the same side of the boundary as the projected point are included in the interpolation. The result of this interpolation technique is that the colors on different sides of the boundary are not mixed and do not result in blurring in the rendered image.

The above color interpolation formulas have the advantage of being simple and therefore efficient to implement in existing graphics hardware. In particular, define the function h to represent the linear interpolation function, i.e.,
h(t,A,B)=(1−t)A+tB,
which is currently available in hardware. Then define
g(x,y)=h(y,h(x,C₃,C₄),h(x,C₁,C₂)).

We can now rewrite Table 1 as follows:

TABLE 2

| Corners in Region | Color of Point (x,y) |
|---|---|
| C₃ | g(0,0) |
| C₃, C₄ | g(x,0) |
| C₁, C₃, C₄ | g(x,0) + g(0,y) − g(0,0) |
| C₁, C₂, C₃, C₄ | g(x,y) |

Thus, using hardware linear interpolation function alone, the values g(0,0), g(x,0), g(0,y), and g(x,y) can all be calculated. Depending on the particular case, the appropriate color value is easily determined from these four values. Note that this table shows examples of particular cases for one, two, and three corners. Generalization to all cases is straightforward.

In order to reduce the memory requirements, implementations of some embodiments can efficiently store the silmap information in a single byte. For example, two bits can be used to store boundary connectivity information and the remaining six bits can be used to store the (x,y) position information of the silmap point (i.e., three bits per coordinate, giving an 8×8 sub-cellular grid of possible silmap points).

Because the boundary position information in a silmap has higher resolution than the corresponding bitmap texture, to avoid animation flickering of minimized textures it is preferable in some embodiments to perform a preprocessing step prior to rendering. In particular, after the silmap and bitmap are created, an average color for each cell in the silmap is calculated by weighting each corner color by the area of its respective skewed quadrant. For example, as shown in FIG. 6B, quadrant 1 has a larger area than the other quadrants, so the color value for the quadrant 1 corner will have a proportionately larger weight in the average color calculated for the cell. This averaging results in a bitmap of filtered colors at the same resolution of the original bitmap. This filtered bitmap is then mipmapped to produce various lower-resolution versions using techniques well known in the art. The filtered bitmap is then used whenever the screen/texture ratio is 1:1 to avoid aliasing. Preferably, to prevent popping during the switch from the original bitmap and the filtered bitmap and mipmap, it may be preferable in some implementations to blend between levels.

In some embodiments silmap cells contain multiple silmap points and additional boundary connectivity information. It is also possible in some implementations for the silmap grid to have a higher resolution than the bitmap texture or depth map grid. These alternatives can be used to provide even higher resolution boundary definition.

Other Embodiments

Finally, other embodiments of the invention include applications other than rendering. In one such embodiment of the invention, a silmap is used to store data with better resolution than with a conventional two-dimensional or multidimensional grid. For example, scientific simulations often involve a grid of values to represent a variable in space. In order to faithfully reproduce discontinuities of this variable, the grid has to be either set very finely across the entire space of the simulation (which results in tremendous memory consumption) or to be hierarchical or adaptive which allows higher resolutions in only the regions that need it. Hierarchical or adaptive algorithms can be complicated and unbounded and can be difficult to accelerate with hardware. By coupling silhouette maps along with the regular data structure, the data would be represented with a piecewise linear approximation which is greatly improved over the piecewise constant approximation afforded by the regular grid structure. Thus, this embodiment of the invention would allow better precision in scientific computation while minimal additional computational and memory costs. Since one of the goals of computer simulation research is to reduce computational and memory overhead, this invention would be an advance in the art of computer simulation.

In other embodiments, the values stored in the texture do not represent colors or depth values but have other interpretations. For example, the embodiment above describes the texture as storing the values of a variable for physical simulation in space. Other embodiments could store indexes to more complex abstractions, for example small 2-D arrays of texture information called texture patches. During rendering, the silmap points are used to determine discontinuities and only the texture patches located on the same side of the discontinuity would be blended together to yield the final result. Thus the manner in which the data stored in the regular grid is to be used along with the boundary information stored in the silmap is very application-specific. However, the implementation details for various applications will be evident to someone skilled in the art in view of the present description illustrating the principles of the invention.

1. A computer-implemented method for rendering objects in a scene, the method comprising:
mapping a point in the scene to a projected point in two-dimensional grid of cells, wherein the image point is contained in a current cell; and
computing a rendered value for the projected point from: i) stored values associated with corners of the current cell and ii) stored boundary position information associated with the current cell.

2. The method of claim 1 wherein the boundary position information comprises a point in the cell.

3. The method of claim 1 wherein the boundary position information comprises boundary connectivity information.

4. The method of claim 1 wherein the stored values are colors.

5. The method of claim 1 wherein the stored boundary position information describes a boundary between differently colored regions of a bitmap texture.

6. The method of claim 1 wherein computing the rendered value for the projected point comprises: reconstructing a boundary within the current cell from the stored boundary position information, identifying a subset of the stored values corresponding to a subset of the corners of the current cell positioned on a same side of the reconstructed boundary as the projected point, and interpolating between the identified subset of stored values.

7. The method of claim 1 wherein the stored values are depth values.

8. The method of claim 1 wherein the stored boundary position information describes an edge of a shadow.

9. The method of claim 1 wherein computing the rendered value for the projected point comprises: dividing the current cell into four skewed quadrants using the stored boundary position information, identifying a quadrant containing the projected point, and selecting a stored value associated with the identified quadrant.

10. A method for generating a silhouette map, the method comprising:
providing a boundary contour and a two-dimensional grid of cells upon which the boundary contour is positioned;
selecting a subset of the cells, wherein the subset of cells covers the boundary contour;
selecting a set of points positioned within the subset of the cells, wherein the points intersect the boundary contour;
storing the set of points in a two-dimensional data structure associated with the grid of cells;
storing a set of values in the two-dimensional data structure, where the values are associated with corners of the cells.

11. The method of claim 10 wherein selecting a subset of cells comprises approximating the boundary contour by a piecewise linear contour and rasterizing the piecewise linear contour to select the subset of cells.

12. The method of claim 10 wherein the set of values are depth values.

13. The method of claim 10 wherein the set of values are color values.

14. The method of claim 10 further comprising storing in the two-dimensional data structure boundary connectivity information.
